(19) United States
(12) Patent Application Publication
(10) Pub. No.: US 2015/0317576 A1
(43) Pub. Date: Nov. 5, 2015

(54) FRAMEWORK FOR ASSESSING THE SENSITIVITY OF PRODUCTIVITY MEASURES TO EXOGENOUS FACTORS AND OPERATIONAL DECISIONS AND FOR THE COMPUTER GENERATED PROPOSAL OF OPTIMAL OPERATING PLANS

(71) Applicant: OpenLink Financial LLC, Uniondale, NY (US)

(72) Inventor: Henry BONNER, Westport, CT (US)

(73) Assignee: OPENLINK FINANCIAL LLC, Uniondale, NY (US)

(21) Appl. No.: 14/268,836

(22) Filed: May 2, 2014

(51) Int. Cl. G06Q 10/06

(52) U.S. Cl. CPC G06Q 10/0635

(57) ABSTRACT

The present disclosure is directed to a framework for modelling the effects on exogenous factors on an operating plan that captures how a business would react to variability of exogenous factors as well as the effect of simultaneously implementing various operating decisions. The framework can also generate optimal operating plans given variability of exogenous factors and reactive business decisions. The framework offers strategic risk management decision support for a business producing goods that are heavily exposed to raw material prices in the commodity markets. The framework accounts for both exogenous factors as well as operational decisions. Specifically, for example, the framework can model corporate earnings and the impact of expenses, revenue, and profit/loss from financial instruments given uncertain exogenous factors while integrating the effects on earnings of operational decisions made in relation to physical assets, real options, and of finished goods selection.

### FIELD OF THE DISCLOSURE

The present disclosure relates generally to predictive modeling of business operating plans. More particularly, the present disclosure relates to a method for modelling the sensitivity of current or future business operating plans to both exogenous factors and to operational decisions made within an operating plan in a single computational framework. In addition, the present disclosure relates to a method for generating candidate operating plans designed to optimize a chosen productivity measure (e.g., earnings) given the assumed exogenous factors and the output objectives of a company.

### BACKGROUND

In today's business world, companies are focusing more than ever on effectively operating their business while reducing their sensitivity to volatile exogenous factors such as market prices for raw materials as well as debt, foreign exchange, customer demand, weather, staffing levels, rent, etc. Reducing a company's sensitivity to exogenous factors is particularly important for companies involved in the production of goods that are highly dependent on raw materials where the main exogenous factors are related to commodity prices. Businesses producing goods whose economic costs are heavily exposed to raw material prices typically manage various activities including: (a) transforming the commodity(ies) from one form to another (e.g., milling, blending, manufacturing, refining, brewing); (b) transporting the commodity or good from one location to another (e.g., shipping, trucking, pipeline); (c) exchanging for money, the commodity or good with another party who places a different value on it (e.g., purchase/sale, speculative/proprietary trading, market timing through storage).

One way companies can reduce their sensitivity to exogenous factor volatility is by minimizing the effects of this volatility on their cost of goods sold. Companies execute this plan by making sure that they buy the raw materials at the best price possible and hedge the prices of these raw materials with derivatives when possible. Accordingly, companies can reduce the direct expense and the volatility of the direct expense, by making more intelligent purchasing decisions of the raw materials used for or producing their goods and where possible, purchasing derivative contracts to hedge the underlying raw material. By reducing their direct expenses and volatility of direct expenses, these companies reduce their sensitivity to raw material price volatility. However, there are a multitude of other volatile exogenous factors that are not taken into account by such companies.

Another way companies attempt to reduce their sensitivity to exogenous factors is by determining how a change in an exogenous variable (for example the price of an ingredient) affects the company's profitability and executing the decision to use an alternative ingredient (input switching). For example, if the price of a raw material increases, the company can determine how this affects the individual product profitability as well as the overall company profitability. However, such determination does not take into account the fact that if the price of a raw material increases, the company might use a different raw material or stop making the product all together.

Companies also need to consider the cost of capital associated with manufacturing, including the time value of money, as well as inventory of finished goods. Companies that only look at product profitability may fail to take into account the cost of capital that is locked in to selling a product. For example, even though a product might appear to be profitable, that product might have sat on the shelf for months and the company could have put a different product on the shelf that sells faster or the raw materials used for the product that sat on the shelf could have been used to produce a different product that is more profitable or one which has a less volatile expense profile.

### SUMMARY

Companies need to evaluate alternative operating plans as well as how well their operating plans respond to volatile exogenous factors. There are many operating choices available to companies related to how they choose to execute their business given their estimates of exogenous factors. These choices or Real Options need to be modelled such that optimal operating plans can be generated given real world constraints. Furthermore, the operating plan should have the ability to morph in predetermined ways to react to the change in exogenous factors or business decisions, for example, input switching described above. Alternative operating plans are also required when companies are making decisions whether to enter or exit markets and products, when to plan outage of manufacturing equipment for maintenance, how to react to forced outage, production output ramps, etc.

A single framework for (i) modelling a business operating plan and (ii) for generating candidate improved plans is disclosed that can simultaneously account for both exogenous factors as well as effects of operational decisions. The framework can model selected productivity measures such as corporate earnings and the impact of expenses, revenue, and profit/loss from financial instruments (e.g., hedging instruments, treasury instruments, debt, etc.) into a single framework which specifically integrates the effects of operational decisions made in relation to physical assets, real options, and finished goods selection. The operating plan can offer strategic risk management decision support for a business producing goods which are heavily exposed to raw material prices in the commodity markets.

The exogenous factors can be modelled as markets, using techniques of stochastic and deterministic scenarios. The operating plan can be modelled using techniques of real options, decision trees, and business rules. The operating plan (actual or hypothetical) can be modelled as compound rainbow options to capture the inherent decisions and reactions to exogenous factors and propose optimal decisions. Techniques such as simulated annealing can be used to generate preferable operating plans and decisions for a set of one or more target productivity measures.

Embodiments disclosed herein provide a new way to model the combined effects on productivity of exogenous factors and business decisions on a business operating plan as well as generate favorable alternative candidate operating plans that integrate exogenous factors and operational decisions.

### BRIEF DESCRIPTION OF THE DRAWINGS

FIG. 1 illustrates an example of a computer-implemented method for determining an operating plan's productivity measure's sensitivity to multiple variables.

FIG. 2 illustrates an example of a goods manufacturing operational decision process.

FIG. 3 illustrates an example of a computer-implemented method for generating an optimal operating plan.

FIG. 4 illustrates an example of a variety of factors that impact productivity measures, e.g., earnings.

FIG. 5 illustrates an example user interface.

### DETAILED DESCRIPTION

The present disclosure is directed to a framework for modelling a business operating plan and for generating alternative candidate operating plans that offer strategic risk management decision support for a business producing goods that are heavily exposed to raw materials, hence prices in the commodity markets. The framework can account for both exogenous factors such as commodity prices as well as operational decisions. Specifically, the framework can model productivity measures such as corporate earnings and the impact of expenses, revenue, and profit/loss from financial instruments (e.g., hedging instruments, treasury instruments, debt, etc.) in a single framework which specifically integrates the effects on productivity measures from operational decisions, for example, those decisions made in relation to physical assets, real options, and finished goods selection. The framework can also generate candidate operating plans designed to optimize a chosen productivity measure (e.g., earnings) given the assumed exogenous factors and the output objectives of the company (e.g., revenue, profits, number of units manufactured, etc.). The framework can not only assess the productivity measure's sensitivity to exogenous factors, but can model the underlying business decisions which form the operating plan.

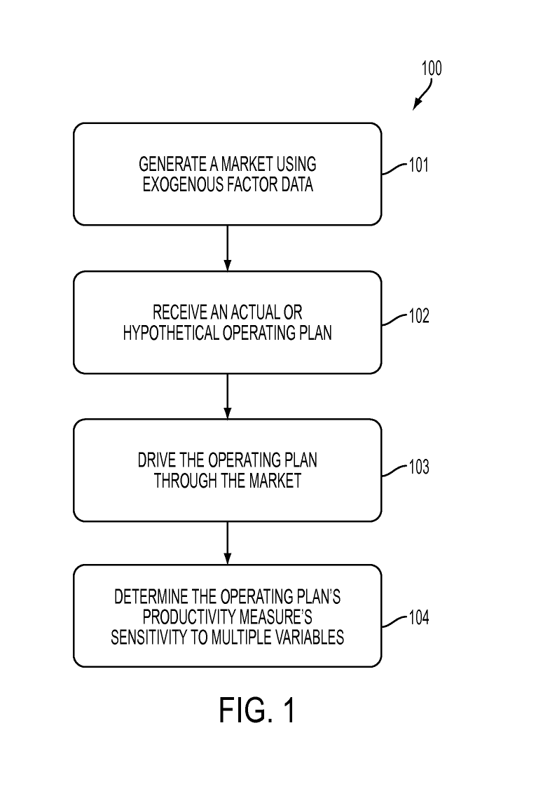

FIG. 1 illustrates an example of a computer-implemented method 100 for determining an operating plan's productivity measure's sensitivity to multiple exogenous variables and operating decisions. At step 101, markets, including forward markets, can be generated using exogenous factor data. The exogenous factors or markets can be simulated using techniques of deterministic and/or stochastic scenarios. These markets can be hypothetical, historical, or actual markets. Exogenous factors can be variables outside the control of a company that impact the market. Examples of exogenous factors include, but are not limited to, commodity prices (raw material, exchange, and OTC prices); treasury prices (FX, MM, etc.); indices such as inflation; weather; demand information (in the form of price/volume elasticity); seasonality (how factors change based on time of year); freight prices; fuel/power prices; human resource rates; rent/leases (real estate, equipment, etc.); and tax information. A market can be one particular view of the exogenous factor data. Markets may be either a single point in time (i.e., a single future day), or a term structure of future values for exogenous factors. The markets can be simulated using current and historical exogenous factor data as well as data regarding how all of these different factors are correlated. Both stochastic and deterministic techniques can be used to project future exogenous factors to create markets (correlated and/or non-correlated).

At step 102, an operating plan can be received which may be the businesses actual operating plan, or some hypothetical, proposed, predicted, projected, candidate, or forecasted plan containing an alternative business construct. The operating plan defines how the organization executes its business and how it reacts to modify its business by making operational decisions. An operating plan can be the complete set of operational decisions for a business to employ, or a sub set representing a single decision or a group of operational decisions.

Operational decisions represent the internal decisions a business makes which often impact expenses, revenue, timing, etc. or both. In addition, operational decisions can be based on other operational decisions creating interdependency. For example, operational decisions include, but are not limited to, product portfolio management, product manufacturing, product distribution (e.g., freight), consumer market/geography entry and exit, and hedge strategies. Product portfolio management operational decisions include decisions related to what products a business should product (e.g., whether to produce product X or Y). Consumer market/geography operational decisions include decisions related to where the business should sell their products including entry, exit, expansion, and contraction options in various markets (e.g., price, volumes, elasticity, etc.). Product distribution operational decisions include decisions related to how to get products to the consumer including what costs and time factors are associated with delivering the finished products to market as well as what costs are associated with storage, inventory, depletion, replacement, spoilage, etc.

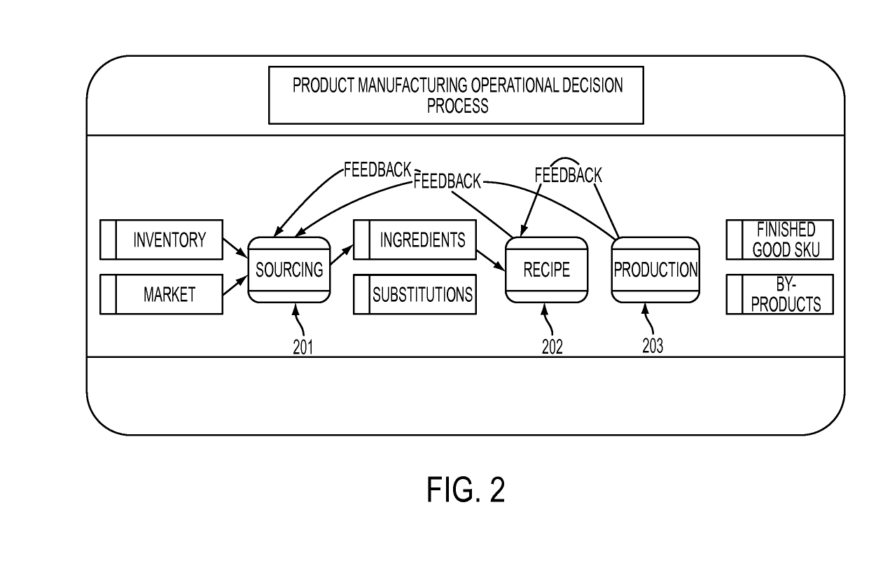

Product manufacturing operational decisions include decisions related to the transformation of raw materials into finished products (e.g., whether to use ingredient A or ingredient B to produce product X). Product manufacturing decisions can further be broken down, for example, into sourcing, recipe, and production operational decisions. FIG. 2 illustrates an example of a product manufacturing operational decisions process.

Sourcing operational decisions 201 include decisions related to how much of each raw material is required for the product production based on the product recipes, where the material is sourced from, what price is paid, etc. These decisions can include whether to use raw materials from inventory or buy from the market considering expected depletion rates from consumption by manufacturing given the current operating plan, replacement cost of inventory (when to replace, market timing, etc), future material requirements/demand, spoilage (perishable) depletion of inventory, and changes in the recipe going forward. Moreover, the sourcing decisions can consider raw material procurement timing for future needs, either physical into storage, or financial for future physical delivery. In addition, the sourcing decisions can take into account feedback from the product and recipe operational decisions.

Recipe operational decisions 202 include decisions related to what ingredients (including substitute ingredients) should be used in manufacturing the finished product. These decisions can be based on changing desired product properties or other aspects such as least cost formulation. In addition, feedback from the sourcing and production decisions can be factored into the recipe decision process based on material cost and availability as well as production asset availability.

Production operational decisions 203 include decisions related to the costs of different production techniques as well as asset management. For example, production decisions can take into account production costs and costs of switching the products that are produced or the asset (equipment) they are produced on. In addition, production asset management considers the availability of an asset to produce the finished product from the raw materials as well as assess outages that can be planned and/or forced (unexpectedly).

At step 103, the operating plan is driven through the generated market. In this step, the productivity measures (for example earnings) associated with the operating plan can be estimated (calculated) across a given time horizon in the market.

At step 104, the operating plan's productivity measure's sensitivity to multiple variables is determined from the estimated productivity measures. The multiple variables include but are not limited to, the exogenous factors and the various operating decisions. The productivity measures can be presented as a distribution function of possible values across a forward term structure, for example, for a given forward market of hypothetical exogenous factors, an associated distribution function of probable earnings values can be produced taking into account the operating decisions which would be made across the time horizon selected.

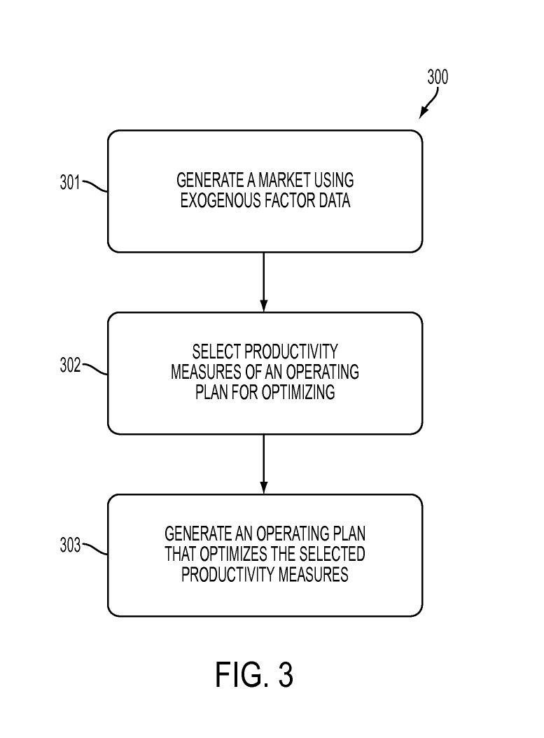

FIG. 3 illustrates an embodiment of a computer-implemented method 300 of generating a candidate operating plan. At step 301, markets can be generated using exogenous factor data similar to those markets generated in step 101 of FIG. 1 discussed above.

At step 302, one or more productivity measure(s) is selected for optimization as well as any operating constraints. Examples of productivity measures can be the earnings amount the company wishes to achieve, volume of finished goods, revenue, expenses, etc. Another example productivity measure is related to item optimization. Using techniques of risk adjusted performance measurement, portfolios of finished goods can be assessed to identify higher performing finished goods on a risk adjusted scale. As such, the productivity measure can be to present a proposed portfolio of finished goods which maximize return for a given risk appetite. This risk adjusted performance measurement can be applied to other parts of the business which consume capital and return profit or loss and may be used to rank the effectiveness of various parts of the business or operating plan.

In step 303, techniques of simulated annealing can be employed to generate and present operating plans which maximize the productivity measure selected in step 302. The simulated annealing technique can drive the candidate operating plans through the term structure of the market produced by step 301, to present an operating plan which is most able to support the productivity measure. The operating plan generated can be capable of coping with the change (i.e., the plan morph in response to factors) in exogenous factors in the term structure of the market. The operating plan can be a variant of the current operating plan or any hypothetical operating plan.

An operating plan can be generated which is optimal for one or more selected production measures, typically, but not limited to, earnings or earnings volatility. The operating plan can be hypothetical, historical, or actual. The operating plan generated can be the complete set of operational decisions for a business to employ, or a sub set representing a single or a group or processes. Using techniques of simulated annealing, operating plans can be generated that optimize business operations for a given performance measure objective. An example of a selected performance measure objective would be minimizing earnings volatility given uncertainty in the markets. Minimization of earnings volatility in the markets refers to the earnings being relatively neutral to the variability of all the exogenous factors used to create the markets, i.e., the operating plan's earnings will be minimally affected by any change in the exogenous factors. For example, if a commodity price changes, the weather changes, and/or the product demand changes (etc.), the operating plan's earnings will be minimally affected. This can be achieved not only by hedging the exogenous factor, but by the ability of the operating plan to morph.

One way to generate an operating plan that optimizes for a selected productivity measure is by using simulated annealing. Simulated annealing can estimate optimal operating plans and underlying operational decisions against a maximization/minimization constraint (margin, EBITDA, finished goods volume). Simulated annealing can be used to find steady state recommendations for alternative operating plans in current and future markets. In addition, an operating plan can be generated based on a particular tolerance the business may have for variability of an exogenous factor.

Various techniques can be used to model the operational decisions of the operating plan. For example, the operational decisions can be generated based on a core set of business rules. The core set of business rules can be modelled as decisions trees or as real options particularly where there is economic benefit in the decision. Furthermore, the operational decisions generated can be dynamic, i.e., the decisions generated may change in predetermined ways to react to the exogenous factors and the corresponding markets. Accordingly, the operational decisions and therefore the corresponding operating plan generated can reflect how a business would behave in changing market conditions. In addition, the operational decisions can be modelled as a series of interconnected decisions which can be represented as compound rainbow options.

In both method 100 and 300, various productivity measures can be estimated associated with the various exogenous factors and the operational decisions of the operating plan. The various productivity measures can be estimated in order to determine the operating plan's productivity measures' sensitivity as well as in order to determine an optimal operating plan. One such productivity measure often calculated is a business's earnings.

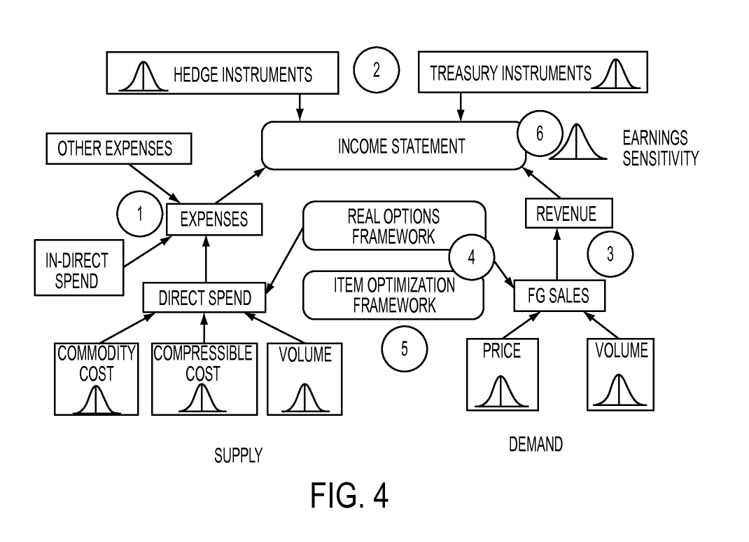

FIG. 4 illustrates an example of a variety of factors that impact a business's productivity measures, e.g., earnings. The real options framework 4 represents the operational decisions. Given the underlying operational decisions, the business's productivity measures can be estimated for a given market.

For example, to calculate a business's earnings across a given time horizon, the business's expenses 1 and revenue 3 can be calculated against a series of hypothetical exogenous factors to result in a distribution of possible earnings figures, taking into consideration the changes to operational process which may be made across the time horizon in response to the change in exogenous factors or for ordinary business course. Expenses 1 include both indirect and direct expenses associated with the manufacture of a good. Any other items can be included such that a holistic representation of all expenses on the income statement 6 is calculated.

Direct and indirect expenses can be the costs that a manufacturer would incur in terms of producing the goods. This includes, for example, costs such as freight, storage, packaging, etc, and commodity costs (raw materials), as well as human resources, assets, real estate, etc. Each of these costs is volatile because they can be directly affected by exogenous factors in the market.

The direct expenses can be calculated by a formula relating the proportional components of a finished product in the form of commodities and non-commodities with associated volumes and prices.

On the other hand, indirect expenses include other expenses only indirectly related to the costs that a manufacturer would have in terms of producing the goods.

Revenue 3 includes income generated by sales of goods. Besides expenses 2 and revenue 3, a business's earnings can be affected by hedge and treasury instruments 2 (financial instruments). These financial instruments include, but are not limited to, debt, interest rate exposure, currency exposure, etc. In addition, a business may be hedging the underlying commodities. Profits and losses from hedge instruments and treasury instruments can be estimated for current and forward markets. For example, standard hedge prescriptions can be determined as a function of the commodities forming the direct expenses. Hedge prescriptions can also morph through time based on the prevailing operating plan. Furthermore, the treasury instruments can be affected by the underlying operational decisions and the given market.

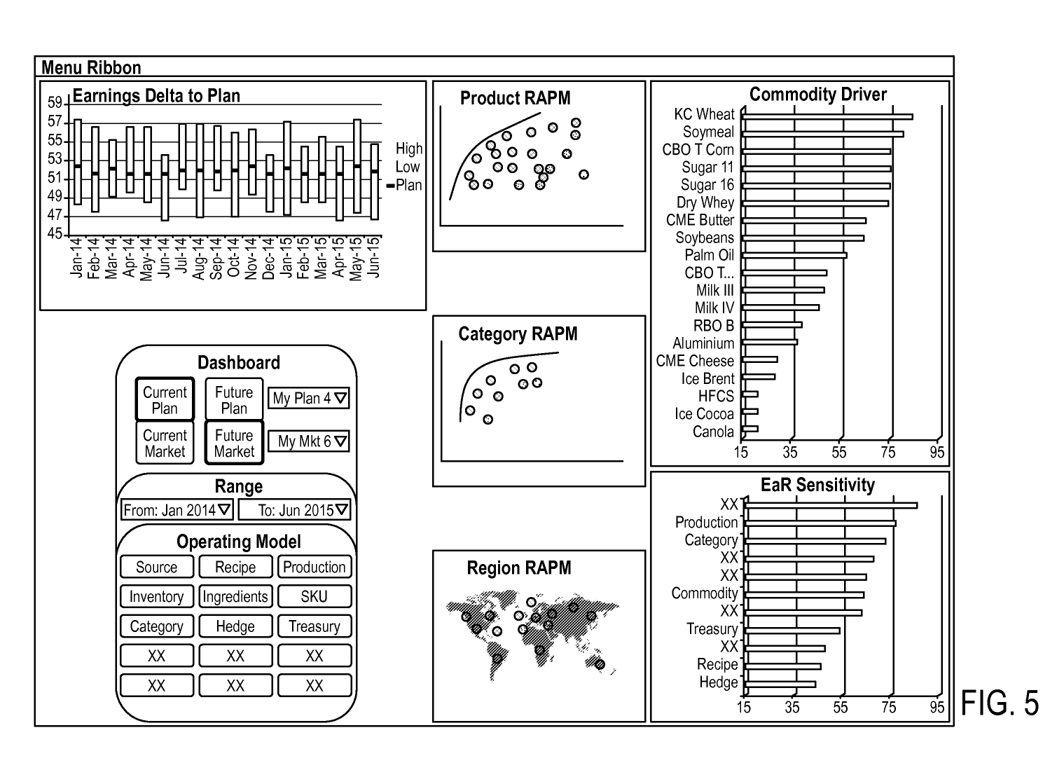

The results and various steps of both methods 100 and 300 can be displayed on a user interface. FIG. 5 illustrates an example of such user interface. The user interface can allow a user to enter static data (exogenous factors or operational decisions) including, for example, commodity names, commodity prices, business unit names, finished good names, etc. Besides displaying any operating plan, the user interface can also allow the user to define specific operational decisions or whole operating plans. The interface can allow the user to perform “what-if” scenarios and control the stochastic and deterministic processes that generate the markets, operating plans and the underlying operational decisions as well as manage the simulated annealing process for candidate operating plan proposal. The interface can also allow a user to be able to drill down to define the specific exogenous factor or operational decisions and determine the effect defining such inputs has on the operating plan.

The user interface can also include a dashboard that allows a user to compare and contrast the current operating plan or any hypothetical operating plan in current market conditions or some hypothetical (future) market. The user interface can display the productivity measures (e.g., earnings volatility) for a given plan in a given market (Earnings Delta to Plan in FIG. 5). Continuing the example, in addition, for a given plan and market, the user interface can display earnings sensitivity to all exogenous factors (commodity driver in FIG. 5), thereby showing the effect each exogenous factor has on the earnings. In addition, the user interface can display the earnings sensitivity to all the operational decisions (EaR Sensitivity in FIG. 5), thereby showing the effect each operational decision has on the earnings.

Furthermore, the user interface can rank what products, brands, SKUs, sales region, business unit, manufacturing center, and product category, etc. by Risk Adjusted Performance Measure (RAPM). For example, these RAPMs can be generated per finished product, either individually or as a sub-portfolio (category), taking into account the capital consumed or held captive by the finished product, and the volatility of the underlying exogenous factors that contribute to the cost of goods sold.

Additional reporting views in the user interface may include, for example: margin by product, margin by commodity, margin by . . . , risk by . . . , RAPM by . . . , earnings by . . . , expenses by . . . , and revenue by . . . .

An exemplary hardware architecture for implementing certain embodiments is described. Specifically, one embodiment can include a computer communicatively coupled to a network (e.g., the Internet). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (e.g., mouse, trackball, stylist, etc), or the like. In some embodiments, the computer has access to at least one database.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like.

The functionalities and processes described herein can be implemented in suitable computer-executable instructions. The computer-executable instructions may be stored as soft-ware code components or modules on one or more computer readable media. Examples of computer readable media include, but are not limited to, non-volatile memories, volatile memories, DASD arrays, magnetic tapes, floppy diskettes, hard drives, optical storage devices, or any other appropriate computer-readable medium or storage device, etc. In one exemplary embodiment of the disclosure, the computer-executable instructions may include lines of compiled C++, Java, HTML, or any other programming or scripting code.

Additionally, the functions of the present disclosure may be implemented on one computer or shared/distributed among two or more computers in or across a network. Communications between computers implementing embodiments of the disclosure can be accomplished using any electronic, optical, radio frequency signals, or other suitable methods and tools of communication in compliance with known network protocols.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A computer-implemented method comprising:
generating, by a processor, a market using exogenous factor data,
receiving, by a processor, an operating plan comprising at least one operational decision,
calculating, by a processor, productivity measures associated with the operating plan, and
determining, by a processor, a sensitivity associated with the productivity measures to the exogenous factors and the at least one operational decision.

2. The method of claim 1, wherein the market generated is a forward market.

3. The method of claim 1, wherein the operating plan received is a candidate operating plan.

4. The method of claim 1, wherein the operating plan received is defined by a user.

5. The method of claim 1, wherein at least one of operational decision is defined by a user.

6. The method of claim 1, wherein the productivity measures comprise earnings.

7. The method of claim 6, wherein the earnings are calculated using the operating plan's corresponding expenses, revenue, and financial instruments.

8. The method of claim 7, wherein the financial instruments comprise hedging instruments and treasury instruments.

9. The method of claim 1, wherein an exogenous factor in the market is defined by a user.

10. A computer-implemented method comprising:
generating, by a processor, a market using exogenous factor data,
selecting, by a processor, a productivity measure for optimization, and
generating, by a processor, an operating plan that optimizes the selected productivity measure in the generated market.

11. The method of claim 10, wherein the operating plan is generated using simulated annealing.

12. The method of claim 10, wherein the selected productivity measure comprises minimizing earnings volatility in the market.

13. The method of claim 10, wherein multiple productivity measures for optimization are selected.

14. The method of claim 10, wherein the market generated is a forward market.

15. The method of claim 10, wherein an exogenous factor in the market is defined by a user.

16. The method of claim 10, wherein the market generated is defined by a user.

17. The method of claim 1, wherein the selected productivity measure is defined by a user.

18. The method of claim 10, wherein an operational decision of the generated operating plan is defined by a user.
